(19) United States
(12) Patent Application Publication
(10) Pub. No.: US 2020/0261892 A1
(43) Pub. Date: Aug. 20, 2020

(54) NANOCOMPOSITE FOR HYDROGEN PRODUCTION HAVING IMPROVED LIFESPAN PERFORMANCE AND MANUFACTURING METHOD THEREOF

(71) Applicants: Hyundai Motor Company, Seoul (KR); Kia Motors Corporation, Seoul (KR); Industry-University Cooperation Foundation Hanyang University ERICA Campus, Ansan (KR)

(72) Inventors: Seung Hyeon Choi, Suwon (KR); Kyung Moon Lee, Uiwang (KR); Dong Hoon Nam, Suwon (KR); Hoon Mo Park, Seongnam (KR); Ji Min Lee, Seoul (KR); Yong Ho Choa, Seongnam (KR); Joo Hyun Park, Anyang (KR)

(21) Appl. No.: 16/653,376

(22) Filed: Oct. 15, 2019

(30) Foreign Application Priority Data
Feb. 19, 2019 (KR) 10-2019-0019163

(51) Int. Cl. B01J 23/889; B01J 37/08; C01B 3/26; B01J 35/10

(52) U.S. Cl. CPC B01J 23/8892; B01J 37/08; C01B 3/26; B82Y 30/00; B01J 35/1014; B01J 35/1038; B01J 35/1061; B01J 35/1009

(57) ABSTRACT

Disclosed are a nanocomposite including a catalytic material and a porous support having a structure of a blocky structure, a spherical structure, and a combination thereof and a manufacturing method thereof. The nanocomposite may have improved the lifespan performance while being applied to the oxidation-reduction reaction of a high temperature.

### CROSS-REFERENCE TO RELATED APPLICATION

This application claims under 35 U.S.C. § 119(a) the benefit of priority to Korean Patent Application No. 10-2019-0019163 filed on Feb. 19, 2019, the entire contents of which are incorporated herein by reference.

### TECHNICAL FIELD

The present invention relates to a nanocomposite including a catalytic material and a porous support having a structure of a spherical structure, a blocky structure, and a combination thereof and a manufacturing method thereof. The nanocomposite may have improved lifetime performance while being applied to the oxidation-reduction reaction of a high temperature.

### BACKGROUND

Generally, hydrogen (e.g., hydrogen gas) can be obtained by the electrolysis of water or by the steam reforming or the partial oxidation of fossil fuels. In addition, it can be obtained by the gasification or the carbonization of biomass. Hydrogen manufactured by various methods is an efficient energy conversion medium, which can be used as a basic raw material in a wide range of fields such as chemical industry and electronic industry, and is a fuel.

Hydrogen is present as a mixture or a composite in a natural state, and the manufacture of hydrogen can variously begin with water, petroleum, coal, natural gas, and combustible waste. A conversion process into hydrogen is possible only by using electricity, heat, microorganisms, etc., and most of various technologies capable of manufacturing hydrogen are in the basic research or the technology development stage. A currently commercialized hydrogen manufacturing method is almost to reform petroleum or natural gas into steam.

For instance, hydrogen can be manufactured by a thermo-chemical technique or by using a photocatalyst or by a biological technique.

FIG. 1 shows a hydrogen manufacturing method through a thermo-chemical technique in the related art. The thermo-chemical technique specifically manufactures hydrogen through a cycle of the oxidation-reduction reaction using a catalyst and heat energy. As shown in FIG. 1, the hydrogen gas is manufactured while the supplied water and catalyst perform the oxidation reaction and the reduction reaction through external heat energy. At this time, the catalyst continuously performs the oxidation and reduction reaction in a reaction space kept at a high temperature, and in this case, the catalyst is partially sintered or phase-separated, and as a result, the efficiency of the oxidation and reduction reaction is reduced, thereby deteriorated the manufacturing yield of hydrogen gas.

In the related art, a catalyst, which continuously performs the oxidation and reduction reaction in a state exposed to the high temperature environment, includes a ceria catalyst.

The above information disclosed in this Background section is only for enhancement of understanding of the background of the disclosure and accordingly it can contain information that does not form the prior art that is already known in this country to a person of ordinary skill in the art.

### SUMMARY OF THE INVENTION

In preferred aspects, provided is a nanocomposite whose particles may not be agglomerated and sintered even in a state exposed to the high temperature environment.

In one aspect, provided is a nanocomposite, which can improve the catalyst efficiency while reducing the content of a ceria catalytic material containing the rare earth element.

Further, in one aspect, provided is a catalyst, which can provide more reaction zones than the conventional catalyst.

The object of the present invention is not limited to the above-described object. The object of the present invention will become more apparent from the following description, and will be realized by means of the appended claims and a combination thereof.

In one preferred aspect, provided is a nanocomposite for hydrogen production including a porous support including aluminum oxide and silicon oxide; and a catalytic material embedded on the porous support. Preferably, the porous support may include mullite (Al₂O₃.SiO₂).

The term “nanocomposite” as used herein refers to a complexed material having two or more distinct materials having distinct properties and having a size, as measured at the maximum distance connecting two points, less than about 1000 nm, less than about 900 nm, less than about 800 nm, less than about 700 nm, less than about 600 nm, or less than about 500 nm. Preferably, the nanocomposite may suitably have a size ranging from about 1 nm to 1000 nm, from about 10 nm to 900 nm, from about 10 nm to 800 nm, from about 10 nm to 700 nm, from about 10 nm to 600 nm, or from about 10 nm to 500 nm.

The term “porous support” as used herein refers to a solid material that has a rigid or semi-rigid structure and having a plurality of cavities, such as pores and channels, inside and/or outer surface thereof. The cavities may be formed to have micrometer sizes and/or nanoscale sizes, without limitation to the shapes thereof. For example, the pores may have spherical or oval shapes and the size thereof can be measured at the maximum distance connecting two points of the pores. Preferably, the pores may be suitably formed to have a size of about 1 to 1000 Å (0.1 nm to 100 nm), of about 10 to 1000 Å (1 nm to 100 nm), or particularly of about 50 to about 500 Å (5 nm to 500 nm).

Preferably, the porous support may suitably have a structure of a blocky structure, a spherical structure, and a combination thereof.

The term “spherical structure” as used herein refers to a round shape or structure of a solid (e.g., rigid or semi-rigid) material without non-rounded edges or corners.

The catalytic material may suitably include cerium oxide (CeO₂).

The catalytic material may suitably further include one or more of the elements of the lanthanide series.

The catalytic material may further include one or more selected from the group consisting of manganese (Mn), iron (Fe), nickel (Ni), copper (Cu), and zirconium (Zr).

An average diameter of the catalytic material may suitably range from about 5 to about 50 nm, and an average diameter of the porous support may suitably range from about 100 to about 50,000 nm.

The nanocomposite may suitably include the catalytic material in an amount of about 2 to 20 wt % and the porous support in an amount of about 80 to 98 wt %. All the wt % are based on the total weight of the nanocomposite.

A specific surface area of the nanocomposite may range from about 5 to about 50 m²/g, a size of the pore may range from about 50 to about 500 Å, and a specific volume of the pore may range from about 0.02 to about 0.09 cm³/g.

Further provided is a process of water decomposition. The process may include using the nanocomposite as describe herein and performing oxidation-reduction at a temperature of about 1000° C. or greater.

The term “water decomposition” as used herein refers to a process of decomposing (e.g., break down) water molecules into hydrogen molecules and oxygen molecules, for example, by breaking two molecules of water (H₂O) into two molecules of hydrogen (H₂) and one molecule of oxygen (O₂).

In another aspect, provided is a method for manufacturing a nanocomposite for hydrogen production. The method may include preparing a raw material including catalytic material particles and support particles; manufacturing an admixture by mixing the catalytic material particles and the support particles; manufacturing a composite by wet-milling the mixture; and manufacturing a nanocomposite by calcining the composite. The catalytic material particles may suitably include cerium oxide (CeO₂) and the support particles may suitably include aluminum oxide and silicon oxide. Preferably, the support particles may suitably include mullite (Al₂O₃.SiO₂).

The raw material may suitably include an amount of about 2 to 20 wt % of the catalytic material particles and an amount of about 80 to 98 wt % of the support particles based on the total weight of the raw material.

The admixture may be manufactured by mixing the catalytic material particles and the support particles together with solvent, and the solvent may suitably include one or more selected from the group consisting of anhydrous methanol, anhydrous ethanol, and acetone.

The admixture may suitably be manufactured by mixing the catalytic material particles, the support particles, and a zirconium oxide (ZrO₂) ball. The size of the zirconium oxide ball may suitably range from about 1 to about 5 mm, and the zirconium oxide ball may be suitably mixed in an amount of about 500 to 800 wt % based on 100 wt % of the raw material.

The wet milling may suitably be performed for about 0.5 to 24 hours at about 200 to 500 rpm. Preferably, the wet milling may be performed by the Attrition milling.

The calcining may suitably be performed for about 1 to 10 hours at a temperature of about 700° C. or greater.

The method for manufacturing the nanocomposite for hydrogen production may further include manufacturing a polymer mixture by mixing the composite with polymer before manufacturing the nanocomposite; and molding the polymer mixture.

Further provided is an apparatus comprising the nanocomposite as described herein. The apparatus may be suitably used for water decomposition.

Accordingly, provided herein is a catalyst whose particles may not agglomerated and sintered even in a state exposed to the high temperature environment. Moreover, provided is a catalyst that may improve the catalyst efficiency than the conventional one while improving the economy by reducing the content of the ceria catalytic material containing the rare earth element. Also provided is a catalyst, which may provide more reaction zones than the conventional one.

Other aspects of the invention are disclosed infra.

### BRIEF DESCRIPTION OF THE DRAWINGS

The above and other features of the present invention will now be described in detail with reference to various exemplary embodiments thereof illustrated the accompanying drawings which are given herein below by way of illustration only, and thus are not limitative of the present invention, and wherein:

FIG. 1 is shows a conventional hydrogen manufacturing method through a thermo-chemical technique.

FIG. 2 shows an exemplary nanocomposite according to an exemplary embodiment of the present invention.

FIG. 3 shows a flowchart of an exemplary manufacturing process of an exemplary nanocomposite according to an exemplary embodiment of the present invention.

FIG. 4 shows an exemplary nanocomposite molded to have a specific shape according to an exemplary embodiment of the present invention.

FIG. 5 shows the photographs of a Field-Emission Scanning Electron Microscope (FE-SEM) of the resultant manufactured through Manufacturing Example 2 to Manufacturing Example 7.

FIG. 6 shows the photographs of the Field-Emission Scanning Electron Microscope (FE-SEM) for an exemplary nanocomposite according to an exemplary embodiment of the present invention.

FIG. 7 shows the analyzed photographs of an X-ray spectrometer of an exemplary nanocomposite according to an exemplary embodiment of the present invention.

FIGS. 8A and 8B is a diagram illustrating the photographs of the Field-Emission Scanning Electron Microscope (FE-SEM) after calcining cerium oxide (CeO₂) particles of Comparative Example 1.

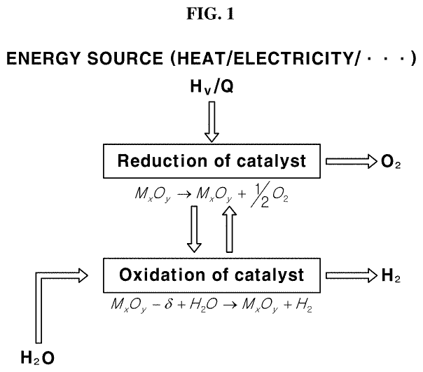

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in section by the particular intended application and use environment.

In the figures, reference numbers refer to the same or equivalent sections of the present invention throughout the several figures of the drawing.

### DETAILED DESCRIPTION

The above-described objects, other objects, features, and advantages of the present invention will be easily understood from the following preferred embodiments relevant to the accompanying drawings. However, the present invention is not limited to the embodiments described herein and can also be embodied in other forms. Rather, the embodiments disclosed herein are provided so that this disclosure will be thorough and complete, and will fully convey the concept of the invention to those skilled in the art.

In this specification, it should be understood that the terms “comprises” or “having” and the like refer to the presence of stated features, integers, steps, operations, components, parts, or a combination thereof, and do not preclude the possibility of the presence or the addition of one or more other features, integers, steps, operations, components, parts, or a combination thereof in advance. In addition, if a portion such as a layer, film, region, plate, or the like is referred to as being “on” another portion, this includes not only the case where it is “directly on” another portion, but also the case where there is another portion therebetween. On the contrary, if a portion such as a layer, film, region, plate or the like is referred to as being “under” another part, it includes not only the case where it is “directly under” another part, but also the case where there is another part therebetween.

Unless otherwise specified, it should be understood that all numbers, values, and/or representations that express the amount of components, reaction conditions, polymer compositions and compounds used in this specification are an approximation that has reflected various uncertainties of the measurement occurred for obtaining these values from the others, which are essentially different therefrom, such that these are expressed by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when a numerical range is disclosed in this specification, such a range is contiguous and includes all values from the minimum value of this range to the maximum value including the maximum value unless otherwise indicated. Furthermore, when such a range refers to an integer, all integers including the minimum value to the maximum value including the maximum value are included therein unless otherwise indicated.

In one aspect, provided, inter alia, is a nanocomposite for hydrogen production including a porous support including aluminum oxide and silicon oxide, for example, mullite (Al₂O₃.SiO₂) and a catalytic material embedded on the porous support and a manufacturing method thereof.

In another aspect, provided is a material of a nanocomposite and a manufacturing method of the nanocomposite will be described, respectively.

Nanocomposite

A nanocomposite of the present invention may be a catalyst used for decomposing water through heat energy, and a main function thereof may be producing hydrogen and oxygen gases while repeatedly performing the oxidation and reduction reaction.

The nanocomposite may suitably include a porous support and a catalytic material. Particularly, the catalytic material is included by being embedded on the porous support.

The catalytic material of the present invention may be used for smoothly performing the thermal decomposition reaction of water, and suitably include cerium oxide (CeO₂).

The catalytic material may be embedded on the porous support in the form of particles, and the catalytic material may contact the water and oxygen supplied from the outside on the porous support, thereby causing the oxidation and reduction reaction.

The average diameter of the catalytic material may range from about 5 to about 50 nm, or preferably, of about 20 to 30 nm.

The catalytic material may further include one or more of the elements of the lanthanide series. For instance, the element of the lanthanide series may be doped thereon. Particularly, the element used for doping may include one or more selected from the group consisting of tantalum (Ta), lanthanum (La), samarium (Sm), and gadolinium (Gd). The content of the element of the lanthanide series may be less than about 10 wt % based on 100 wt % of the total catalytic material.

The catalytic material can further include one or more selected from the group consisting of manganese (Mn), iron (Fe), nickel (Ni), copper (Cu), and zirconium (Zr). For instance, the catalytic material can further include an oxide having a form of the following Chemical formula 1.

MₓO_{y} Chemical formula 1

M in Chemical formula 1 is one selected from the group consisting of Mn, Fe, Ni, Cu, Zr, and a combination thereof, x is one of the integers of 0 to 5, and y is one of the integers of 0 to 5.

At this time, the oxide may be contained in an amount less than about 50 wt % based on the total 100 wt % of the catalytic material.

The nanocomposite may suitably include a content of the catalytic material in an amount of about 2 to 20 wt % based on the total weight of the nanocomposite. When the average diameter and the content of the catalytic material are less than the above range, a sufficient reaction zone may not be provided on the porous support, such that the oxidation and reduction reaction may not be performed smoothly. When the average diameter and the content of the catalytic material are less greater than the above range, the agglomeration between the catalytic materials may occur at a high temperature, thereby reducing the catalyst efficiency and the durability of the nanocomposite.

The porous support may contain mullite (Al₂O₃.SiO₂), and since the porous support has a high resistance against high temperature heat, the deformation in shape and the reduction in durability may not occur even when exposed to the high temperature environment.

The porous support may function so that the respective catalytic materials may be fixed with a certain interval in order to prevent the agglomeration between the catalytic materials from occurring at a high temperature. In addition, since the porous support includes a large number of pores in the interior and exterior thereof, it may provide more reaction zones.

A structure of the porous support may be one selected from a blocky structure, a spherical structure, and a combination thereof. For instance, the blocky structure as used herein refers to a structure including an angular agglomerated structure. In addition, the spherical structure as used herein refers to a structure including an agglomerated structure with a spherical shape.

The porous support may be in a form in which the mullite particles that are the support particles may be agglomerated. When the support particles are agglomerated, the porous support may have pores and interstices due to a gap formed partially.

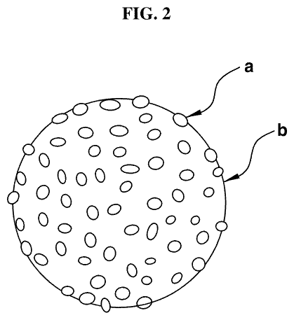

FIG. 2 shows an exemplary embodiment of the nanocomposite. As shown in FIG. 2, it can be seen that when the porous support (b) has a spherical structure, the catalytic material (a) has been embedded on the porous support (b) in the form of the particles.

As described above, although the porous support has various structures, the average diameter thereof may suitably ranges from about 100 to about 50,000 nm. When the average diameter of the porous support is less than about 100 nm, the porous support may have almost no difference in size from the catalytic material, such that the catalytic material may not be entirely embedded on the porous support.

The nanocomposite may include the content of the porous support in am amount of about 80 to 98 wt % based on the total weight of the nanocomposite.

The nanocomposite including the catalytic material and the porous support may have the specific surface area from about 5 to 50 m²/g, and have pores having a size of about 50 to 500 Å and a specific volume of about 0.02 to 0.09 cm³/g.

The nanocomposite may be suitably used in the water decomposition and hydrogen production processes that repeat the oxidation-reduction in the temperature of about 1000° C. or greater. Preferably, the nanocomposite may be used in the temperature of about 1300° C. or greater.

Manufacturing Method of the Nanocomposite

A manufacturing method of the nanocomposite may include preparing the catalytic material particles and the support particles, manufacturing an admixture by mixing the catalytic material particles and the support particles, manufacturing a composite by wet-milling the mixture, and manufacturing the nanocomposite by calcining the composite.

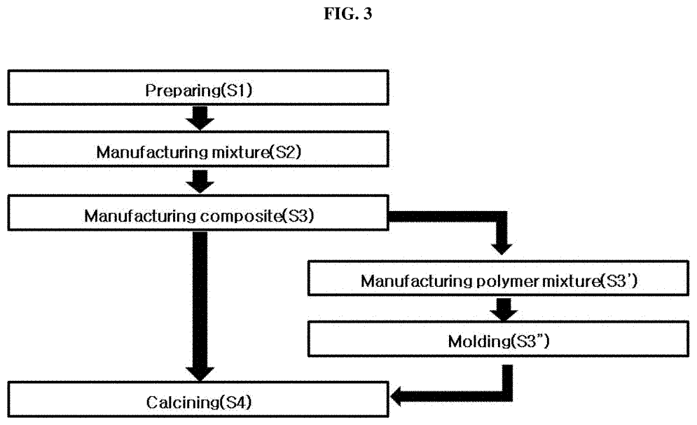

FIG. 3 is a flowchart of a manufacturing process of the nanocomposite. Each will be described in detail with reference to FIG. 3.

Preparing S1

Preparing S1 may include preparing a raw material containing the catalytic material particles and the support particles. The catalytic material particles are a raw material for forming the catalytic material of the nanocomposite, and the support particles are a raw material for forming the porous support of the nanocomposite.

The raw material may suitably include the catalytic material particlesin an amount of about 2 to 20 wt % and the support particles in an amount of about 80 to 98 wt % based on the total weight of the raw material.

Manufacturing a Mixture S2

Manufacturing a mixture S2 may include manufacturing the admixture by mixing the catalytic material particles and the support particles that are a raw material. Particularly, the mixing may include injecting the catalytic material particles and the support particles prepared at the certain ratio into solvent. The solvent preferably may include one or more selected from the group consisting of anhydrous ethanol, anhydrous methanol, and acetone.

The solvent may be suitably included by about 300 to 500 wt % based on 100 wt % of the raw material.

For instance, a ball may be further injected into the solvent for the wet-milling, preferably using a zirconium oxide (ZrO₂) ball as the ball.

The zirconium oxide ball may be injected therein so that the catalytic material particles and the support particles, which are a raw material, may be well milled in a wet-milling apparatus and mixed and kneaded, and suitably may have 1 to 5 mm in size.

The zirconium oxide ball may be injected in an amount of about 500 to 800 wt % based on 100 wt % of the raw material.

Manufacturing a Composite S3

Manufacturing a composite S3 may include manufacturing a composite by wet-milling the mixture. For instance, the wet milling may suitably be performed through the Attrition milling.

Particularly, the Attrition milling may be much faster in the milling and dispersion times than a general ball mill, a sand mill, and a vibration mill, and can mill the particles more finely than the listed conventional mills. As such, the Attrition milling may be advantageous in that a material having the desired properties can be obtained because the milling time is shorter than that of the conventional milling method, the milling efficiency is high, and the milling accuracy is high. In addition, since the phenomenon in which the milled particles are agglomerated or aggregated with each other is remarkably reduced, the nanocomposite in which the catalytic material has been uniformly dispersed on the support may be obtained.

The Attrition milling mills, mixes, and kneads the mixture by transferring the rotational force of the Attrition milling apparatus thereto, which is performed at the rotational speed of about 200 to 500 rpm for about 0.5 to 24 hours. The Attrition milling may be performed for about 3 to 24 hours, and particularly for about 6 to 24 hours.

The catalytic material and the support, which are a raw material included in the mixture, may be uniformly milled in the form of smaller particles by the Attrition milling and in addition, the raw material can be uniformly dispersed in the solvent.

The mixture obtained by milling, mixing, and kneading through the Attrition milling may be dried to finally form a composite, and at this time, the drying temperature and time may be sufficient as long as it is in the environment capable of removing the solvent and the present invention is not specially limited thereto.

Manufacturing a Polymer Mixture S3′

After the manufacturing the composite, manufacturing a polymer mixture S3′ may include manufacturing a polymer mixture by mixing the composite with polymer before the calcining. This step can be excluded from the process for purposes and needs thereof.

Particularly, in this step, the nanocomposite may be processed to have a specific shape, and the moldable polymer mixture may be manufactured by mixing the composite obtained in the manufacturing the composite S3 with polymer. The polymer mixed at this time may preferably include polyethylene oxide (PEO).

Molding S3″

After the manufacturing the polymer mixture, molding S3″ may include molding the polymer mixture, which may be excluded from the process for purposes and needs thereof.

Particularly, a molded product having a target shape may be obtained by applying pressure and heat to the manufactured polymer mixture. The pressure and the heat applied at this time are not specifically limited thereto, may suitably be changed according to the purpose thereof, and the shape of the molded product may not be limited to the present invention either.

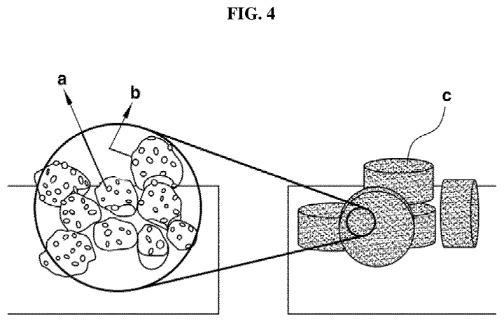

FIG. 4 shows an exemplary molded product (c) manufactured in the form of a disk through the molding. As shown in FIG. 4, the molded product (c) may be formed by compressing the nanocomposite, and the nanocomposite may include the porous support (b) having the blocky structure in which the catalytic material (a) has been embedded.

Calcining S4

Calcining S4 involves manufacturing a nanocomposite by calcining the composite. This step may suitably be performed for the manufactured composite by omitting the manufacturing the polymer mixture S3′ and the molding S3″ after the manufacturing the composite S3, or may be performed for the manufactured molded product without omitting the manufacturing the polymer mixture S3′ and the molding S3″.

The calcining may suitably be performed at a temperature of about 700° C. or greater for about 1 to 10 hours, and preferably performed at a temperature of about 1000° C. or greater.

The impurities and the solvent residuals in the nanocomposite may be completely removed by the calcining, and the bonding force between the catalytic material and the porous support may be further enhanced, thereby improving the crystallinity of the nanocomposite.

### EXAMPLE

Hereinafter, the exemplary embodiments of the present invention will be described in more detail. However, these embodiments are for illustrating the present disclosure and the scope of the present invention is not limited thereto.

### Manufacturing Example 1

A raw material was prepared so that ceria particles, which are a catalytic material having 25 nm of the average particle diameter, and mullite particles, which are a support having 30 μm of the average particle diameter, was prepared to a weight ratio of 20:80, and the zirconia ball having 3 mm of the particle diameter was prepared in an amount of 600 wt % based on the amount of raw material. Thereafter, the raw material and the zirconia ball were injected to anhydrous ethanol, and the Attrition milling process was performed at room temperature for 12 hours at 400 rpm. After the solid matter was separated by centrifugation of the resultant obtained through the Attrition milling process, the composite in powder form was obtained by drying the solid matter in an oven at 70° C. for 24 hours and using a 16 mesh sieve.

### Manufacturing Examples 2 to 7

Prepared were so that the mullite particles, which are a support, having 30 m of the average particle diameter and the zirconia ball having 3 mm of the particle diameter became 500 wt % compared to the mullite. Thereafter, the resultant was obtained by injecting the mullite and the zirconia ball into anhydrous ethanol, and performing the Attrition milling process at room temperature for the duration of time as shown in Table 1 below at 300 rpm.

TABLE 1

| | Manufacturing | Manufacturing | Manufacturing | Manufacturing | Manufacturing | Manufacturing |
|---|---|---|---|---|---|---|
| | Example 2 | Example 3 | Example 4 | Example 5 | Example 6 | Example 7 |
| Milling time | 0.5(hr) | 1(hr) | 2(hr) | 6(hr) | 12(hr) | 24(hr) |

FIG. 5 shows the photographs of a Field Emission Scanning Electron Microscope (FE-SEM) of the resultant manufactured through Manufacturing Examples 2 to 7. As shown in FIG. 5, it can be confirmed that the nanocomposite is manufactured to have the porous support in various sizes from 20 m to 500 nm according to the milling time.

### Example 1

The nanocomposite was manufactured by calcining the composite obtained in Manufacturing Example 1 at a temperature of 1,300° C. for 2 hours in the atmosphere.

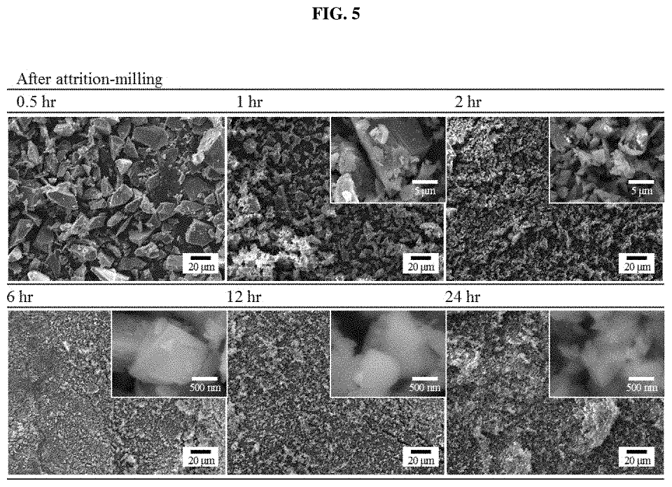

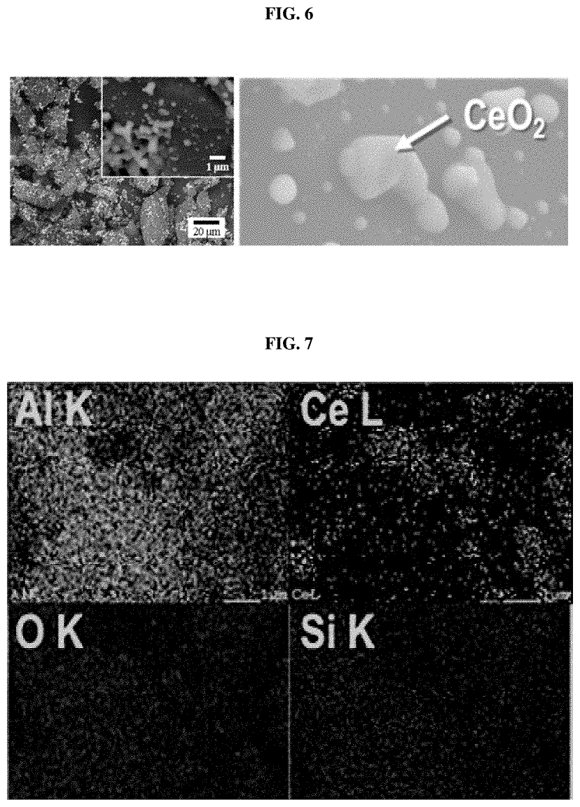

FIG. 6 shows the photographs of the Field Emission Scanning Electron Microscope (FE-SEM) of the manufactured nanocomposite. As shown in FIG. 6, it can be confirmed that cerium oxide (CeO₂), which is a catalytic material, was dispersed and embedded on mullite, which is a porous support in the form of the nano-sized particles. In addition, the analyzed results of the X-ray spectrometer of the nanocomposite were illustrated in FIG. 7. As shown in FIG. 7, it can be confirmed that the nanocomposite contains aluminum (Al), cerium (Ce), silicon (Si), and oxygen (O).

### Example 2

The nanocomposite was manufactured by calcining the composite obtained in Manufacturing Example 4 at a temperature of 1,300° C. for 2 hours in the atmosphere.

### Comparative Example 1

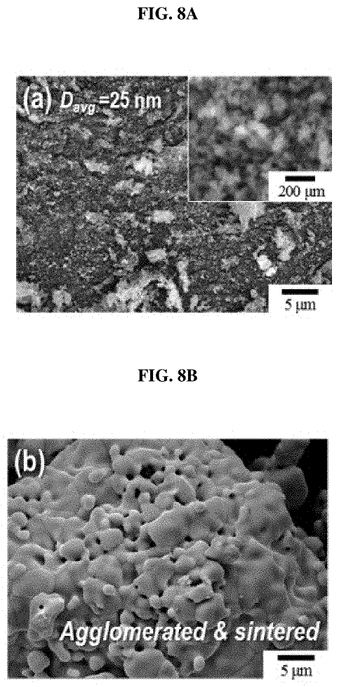

The cerium oxide (CeO₂) particles, which are a catalytic material having 25 nm of the average particle diameter, were calcined at a temperature of 1,300° C. for 2 hours, and the results thereof were illustrated in FIG. 8. FIG. 8 shows the photographs of the Field Emission Scanning Electron Microscope (FE-SEM). As shown in FIG. 8, FIG. 8 confirms the distribution of the cerium oxide particles having 25 nm of the average particle diameter before the calcining (a), while the nano-sized cerium oxide particles after calcining (b) were partially agglomerated and sintered, thereby becoming large.

### Comparative Example 2

The nanocomposite was manufactured in the same manner and environment as in Example 2 except for performing the milling through the Ball milling method rather than the Attrition milling method.

### Comparative Example 3

The nanocomposite was manufactured in the same manner and environment as in Example 1 except for using the support as cordierite ((Mg, Fe²⁺)₂Al₄Si₅O₁₈) rather than mullite.

### Experimental Example 1

The specific surface area analysis (BET) for the nanocomposites of Example 2 and Comparative Example 2 was performed and the results thereof are shown in Table 2 below. The analysis was performed by a method for absorbing nitrogen gas on the surface of the nanocomposite powder to measure the amount of absorbed nitrogen.

TABLE 2

| | Specific surface area | Size of pore | Specific volume |
|---|---|---|---|
| | (m²/g) | (Å) | (cm³/g) |
| Example 2 | 20.1679 | 104.889 | 0.074920 |
| Comparative | 17.7675 | 93.042 | 0.055971 |
| Example 2 | | | |

According to the results, it can be confirmed that Example 2 has a wider specific surface area than that of Comparative Example 2, and the size of the pore and the specific volume of the pore thereof are also greater than those of Comparative Example 2. Therefore, it is possible to obtain the porous support having high porosity and specific surface area through the high energy Attrition milling, and it is possible to sufficiently secure a site where the catalyst reaction can occur by embedding the catalyst therein, thereby increasing the catalytic performance.

### Experimental Example 2

The nanocomposites of Example 1 and Comparative Example 3 were used to measure whether hydrogen was produced according to the water decomposition, and the results thereof were illustrated in Table 3 below.

Particularly, 500 ml of the reactor was prepared to inject the nanocomposites of the Example 1 and the Comparative Example 3 in the reactor by 3.0 g, respectively, and the reactor was heated at a temperature of 1400° C. under the inert argon atmosphere to flow 10 ml of water therein, thereby vaporizing the reactor. Thermal decomposition reaction of water occurs as the nanocomposite is oxidized, and 1 cc of air was collected in the reactor by using a syringe every time the reaction was completed. The amount of produced hydrogen was measured by putting the collected air into the Gas chromatography-mass spectrometry. After the reaction was completed, the reduction of the nanocomposite was sufficiently performed in the inert atmosphere, and 10 ml of water was injected therein again to induce the catalytic reaction. The procedure was repeated five times, and the amount of produced hydrogen obtained for each cycle was illustrated in Table 3 below.

TABLE 3

| | Example 1 | Comparative Example 3 |
|---|---|---|
| | (mL/g ceria) | (mL/g ceria) |
| First | 4.63 | 4.91 |
| Second | 4.60 | 4.26 |
| Third | 4.61 | 4.03 |
| Fourth | 4.58 | 3.76 |
| Fifth | 4.57 | 3.12 |

As shown in Table 3, it can be confirmed that although the amount of produced hydrogen in Comparative Example 3 is greater than that of Example 1 at the first measurement, the amount of produced hydrogen in Comparative Example 3 is remarkably reduced as the experiment is repeated. On the other hand, it can be confirmed that the amount of produced hydrogen of Example 1 has almost no change in the amount of produced hydrogen while the experiment was performed five times.

Therefore, it can be seen that the nanocomposite of the present invention has almost no reduction in catalyst efficiency even when continuously exposed to the high temperature environment.

What is claimed is:

1. A nanocomposite for hydrogen production, comprising:
a porous support comprising aluminum oxide and silicon oxide; and
a catalytic material embedded on the porous support.

2. The nanocomposite of claim 1, wherein the porous support comprises mullite (Al₂O₃.SiO₂).

3. The nanocomposite of claim 1,
wherein the porous support has a structure of a blocky structure, a spherical structure, and a combination thereof.

4. The nanocomposite of claim 1,
wherein the catalytic material comprises cerium oxide (CeO₂).

5. The nanocomposite of claim 4,
wherein the catalytic material further comprises one or more elements of the lanthanide series.

6. The nanocomposite of claim 4,
wherein the catalytic material further comprises one or more selected from the group consisting of manganese (Mn), iron (Fe), nickel (Ni), copper (Cu), and zirconium (Zr).

7. The nanocomposite of claim 1,
wherein an average diameter of the catalytic material ranges from about 5 to about 50 nm, and an average diameter of the porous support ranges from about 100 to about 50,000 nm.

8. The nanocomposite of claim 1,
wherein the nanocomposite comprises the catalytic material comprises in an amount of about 2 to 20 wt % and the porous support in an amount of about 80 to 98 wt %, all the wt % based on the total weight of the nanocomposite.

9. The nanocomposite of claim 1,
wherein a specific surface area of the nanocomposite ranges from about 5 to about 50 m²/g, a size of the pore ranges from about 50 to about 500 Å, and a specific volume of the pore ranges from about 0.02 to about 0.09 cm³/g.

10. A process of water decomposition, comprising
using the nanocomposite of claim 1, and
performing oxidation-reduction at a temperature of about 1000° C. or greater.

11. A method for manufacturing a nanocomposite for hydrogen production, comprising:
preparing a raw material comprising catalytic material particles and support particles;
manufacturing an admixture by mixing the catalytic material particles and the support particles;
manufacturing a composite by wet-milling the mixture; and
manufacturing a nanocomposite by calcining the composite,
wherein the catalytic material particles comprise cerium oxide (CeO₂), and the support particles comprise aluminum oxide and silicon oxide.

12. The method of claim 11, wherein the support particles comprise mullite (Al₂O₃.SiO₂).

13. The method of claim 11,
wherein the raw material comprises an amount of about 2 to 20 wt % of the catalytic material particles and an amount of about 80 to 98 wt % of the support particles based on the total weight of the raw material.

14. The method of claim 11,
wherein the admixture is manufactured by mixing the catalytic material particles and the support particles together with solvent, and
wherein the solvent comprises one or more selected from the group consisting of anhydrous ethanol, anhydrous methanol, and acetone.

15. The method of claim 11,
wherein the admixture is manufactured by mixing the catalytic material particles, the support particles, and a zirconium oxide (ZrO₂) ball,
wherein a size of the zirconium oxide ball ranges from about 1 to about 5 mm, and
wherein the zirconium oxide ball is mixed in an amount of about 500 to 800 wt % based on 100 wt % of the raw material.

16. The method of claim 11,
wherein the wet milling is performed for about 0.5 to 24 hours at about 200 to 500 rpm.

17. The method of claim 16, wherein the wet milling is performed by Attrition milling.

18. The method of claim 11,
wherein the calcining is performed for about 1 to 10 hours at a temperature of about 700° C. or greater.

19. The method of claim 10, further comprising:
manufacturing a polymer mixture by mixing the composite with polymer before manufacturing the nanocomposite; and
molding the polymer mixture.

20. An apparatus for water decomposition comprising a nanocomposite of claim 1.
